(19) United States
(12) Patent Application Publication
(10) Pub. No.: US 2012/0236158 A1
(43) Pub. Date: Sep. 20, 2012

(54) VIRTUAL DIRECTORS' CAMERA

(75) Inventors: Brad Oleksy, Surrey (CA); Troy Thibodeau, Prot Coquitlam (CA); Mike Iguidez, Surrey (CA); Frank Henigman, Burnaby (CA); Ryan Hietanen, Vancouver (CA)

(73) Assignee: ELECTRONIC ARTS INC., Redwood City, CA (US)

(21) Appl. No.: 13/355,566

(22) Filed: Jan. 23, 2012

Related U.S. Application Data
(60) Provisional application No. 61/435,346, filed on Jan. 23, 2011.

(51) Int. Cl. H04N 5/225

(52) U.S. Cl. 348/207.1; 348/E05.024

(57) ABSTRACT

A virtual directors' camera includes a camera module, a processing module and a controller module. In an embodiment, the virtual directors' camera can include a display screen, handles for holding the device, and a controller for changing the settings of the camera. The display can show the action of the motion capture in a scene such as a virtual environment, and can also show the user interface of the software associated with camera operation and control. In a mode of operation, a director can hold onto the handles of the device and view the motion capture in a desired virtual environment, while also being able to control various aspects of the camera settings through a configuration of buttons on the controller of the device.

### BACKGROUND OF THE INVENTION

The present invention relates generally to the field of motion capture technology, and more particularly to a virtual directors' camera for improving the process for visualizing character models and capturing their movements in virtual environments.

Motion capture is the process of recording the movement of performers and translating that movement into a digital format such as an animated character. The process of motion capture involves putting a plurality of markers on various points on the body of the individual whose motion is being captured. A camera records information about the location of those points as the individual (markered talent) moves in a three-dimensional space. The information captured from the marked talent is then mapped onto a digital animation or character model. Motion capture techniques are often used in video game development as a way to animate in-game characters more rapidly than with traditional techniques.

Existing virtual cameras are expensive and cumbersome to operate. What is needed is a portable, flexible virtual directors' camera which provides the ability to see the markered talent in the chosen virtual environment in real time.

### BRIEF SUMMARY OF THE INVENTION

A virtual directors' camera system provides a wireless, real-time camera solution for motion capture. Embodiments advantageously provide efficient acquisition and processing of motion capture data. One skilled in the art will recognize that other uses of the systems and methods disclosed herein might be realized without departing from the spirit of the present invention.

Other features and advantages of the invention will be apparent in view of the following detailed description and preferred embodiments.

### BRIEF DESCRIPTION OF THE DRAWINGS

FIG. 1A is a diagram illustrating a perspective view of a virtual director's camera in accordance with an exemplary embodiment.

FIG. 1B is a diagram illustrating a mode of operation of a virtual directors' camera in accordance with an exemplary embodiment.

FIG. 2 is a diagram illustrating a top view perspective showing a button configuration of a controller of a virtual directors' camera in accordance with an exemplary embodiment.

FIG. 3 is a diagram illustrating a user interface for selecting the environment and characters on a virtual directors' camera, in accordance with an exemplary embodiment.

FIG. 4 is a diagram illustrating a crane function of a virtual director's camera.

FIG. 5 is a diagram illustrating a freeze and offset function of a virtual director's camera.

FIG. 6 is a diagram illustrating a steady camera mode of a virtual director's camera.

FIG. 7 is a diagram illustrating a smooth boom function of a virtual director's camera.

FIG. 8 is a diagram illustrating a focal length function of a virtual director's camera.

FIG. 9 is a diagram illustrating a zoom and focus function of a virtual director's camera.

FIG. 10 is a block diagram illustrating a virtual directors' camera system in accordance with an exemplary embodiment.

FIG. 11 is a block diagram illustrating a virtual directors' camera system in accordance with an exemplary embodiment.

FIG. 12 is a block diagram illustrating a virtual directors' camera system in accordance with an exemplary embodiment.

FIG. 13 is a block diagram illustrating a general purpose processing system for running methods in accordance with an exemplary embodiment.

FIG. 14 is a diagram illustrating a mode of operation of a virtual directors' camera in accordance with an exemplary embodiment.

FIG. 15 is a diagram illustrating elements of a user interface of a virtual directors' camera system in accordance with an exemplary embodiment.

FIG. 16 is a diagram illustrating elements of a user interface of a virtual directors' camera system in accordance with an exemplary embodiment.

FIG. 17 is a diagram illustrating elements of a user interface of a virtual directors' camera system in accordance with an exemplary embodiment.

FIG. 18 is a diagram illustrating elements of a user interface of a virtual directors' camera system in accordance with an exemplary embodiment.

FIG. 19 is a diagram illustrating elements of a user interface of a virtual directors' camera system in accordance with an exemplary embodiment.

### DESCRIPTION OF THE INVENTION

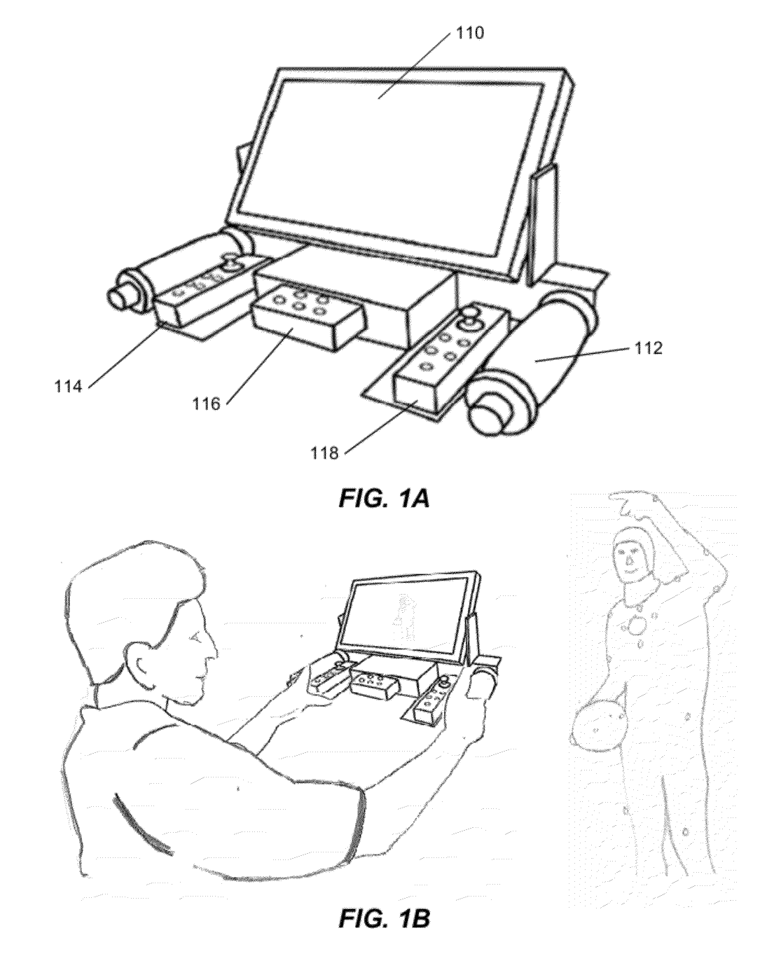

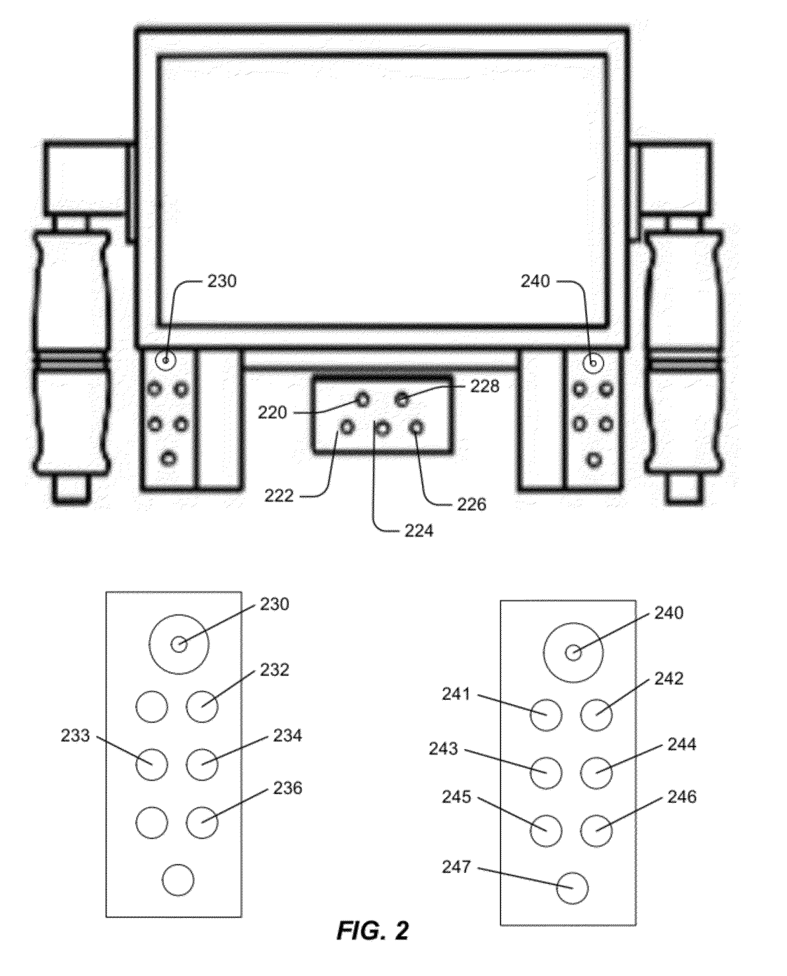

A director's camera allows game developers to add organic, true-to-life cameras into their game. Traditionally, camera creation was done through use of mouse and keyboard key-framing. This was very time consuming and the final result, while good, was not as fluid or organic as a realistic camera. In accordance with an embodiment of the invention, a director's camera allows a camera operator to manipulate a tangible object in a capture volume just as they would a real-life video camera and have every subtle motion recorded into their game. FIG. 1 illustrates a virtual directors' camera according to an embodiment. The virtual directors' camera includes a display screen, handles for holding the device, and a controller for changing the settings of the camera. The display can show the action of the motion capture in a scene such as a virtual environment, and can also show the user interface of the software associated with camera operation and control. In one mode of operation, a director can hold onto the handles of the device and view the motion capture in a desired virtual environment, while also being able to control various aspects of the camera settings through a configuration of buttons on the controller of the device.

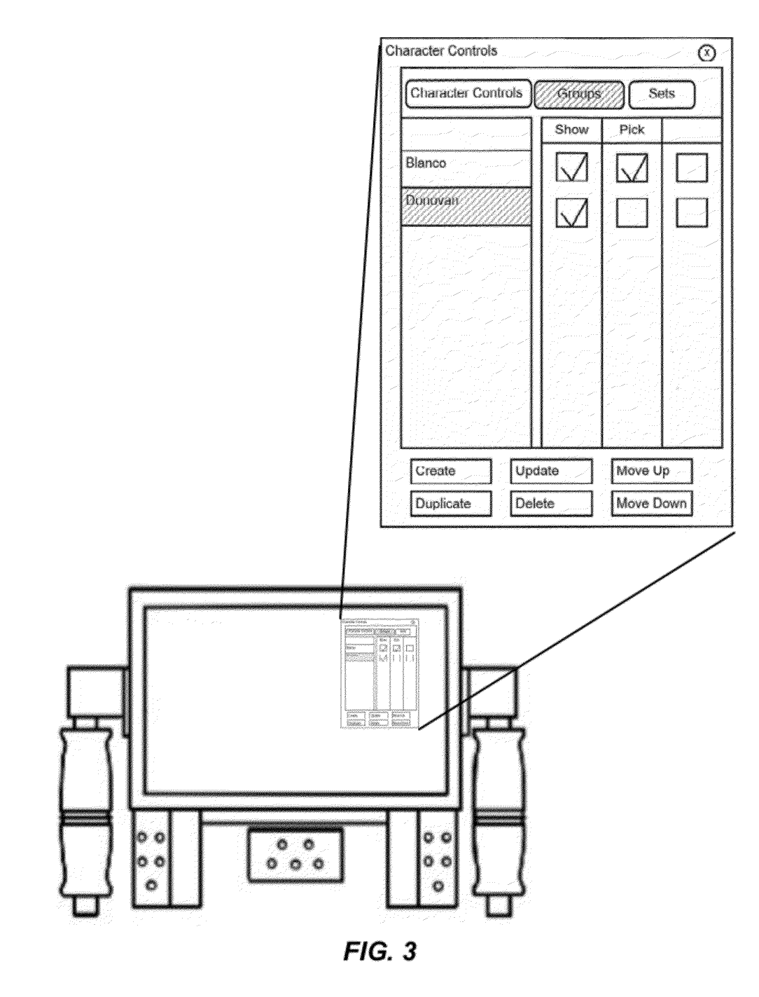

FIG. 2 illustrates a button configuration of a controller of a virtual directors' camera according to an embodiment. In this example embodiment, the controller includes buttons associated functions such as crane speed, crane mode, camera freeze and offset, a camera-steadying mode, a smooth boom (or techno crane mode), character and environment selection, focal lengths, zoom and focus. The zoom in and out functions are shown as trigger buttons on the handles of the device. This button configuration is shown by way of example only, and can be implemented in other ways in accordance with an embodiment.

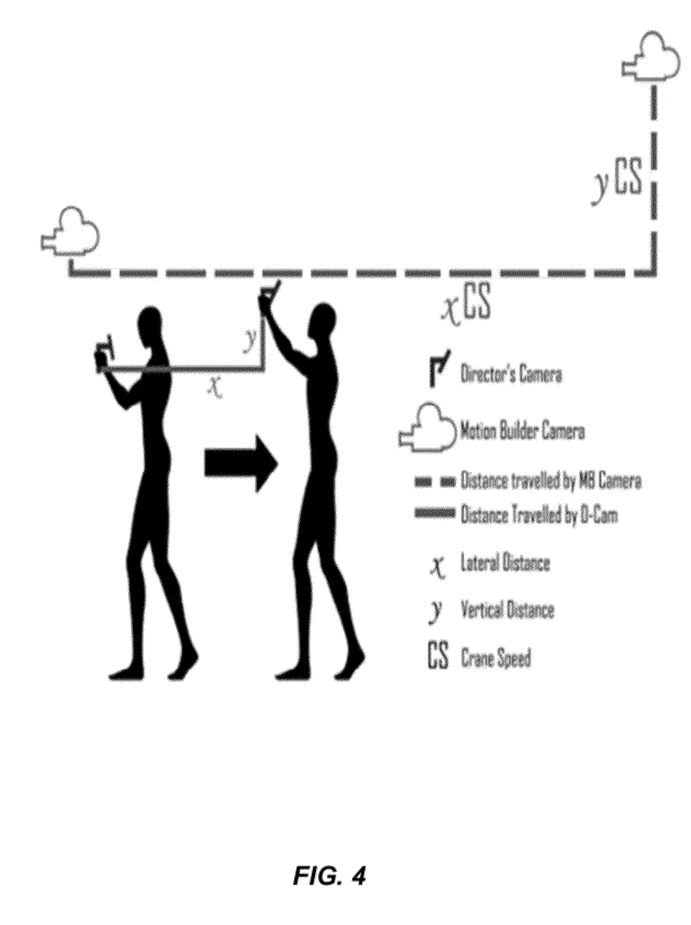

FIG. 3 illustrates an example of a user interface for selecting the environment and characters on a virtual directors' camera according to an embodiment. In the example shown, buttons for character selection, toggling of characters and environment selection are located on the controller of the device so that the individual operating the camera will have easy access to them during capture. The user interface on the screen of the virtual directors' camera shows check boxes for selecting various character controls. These check boxes can be selected by pressing the selection buttons described.

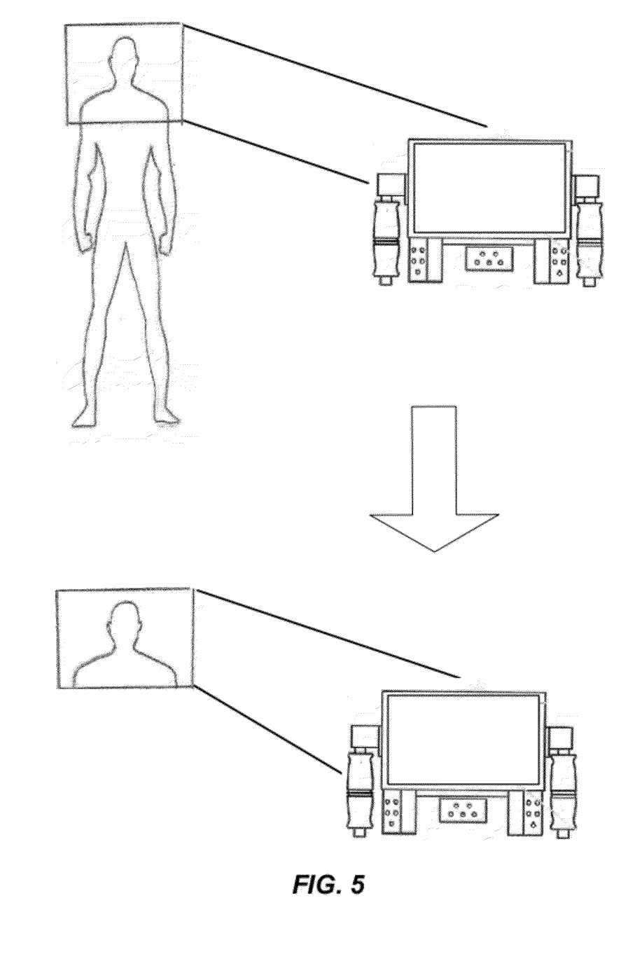

FIG. 4 illustrates a crane function of a virtual directors' camera according to an embodiment. The crane function allows a user to manipulate the translation of the virtual camera (shown here as the “Motion Builder camera”) by amplifying the motion of the physical camera (the directors' camera). When the crane function is turned on, the virtual camera's position can be multiplied from the position of the physical camera in a space. For example, one foot of the physical camera motion can be mapped to eight feet of virtual camera motion. This can provide the person who is operating the camera with the perceived ability to “fly out” a very far distance, as if they were operating the camera on a crane.

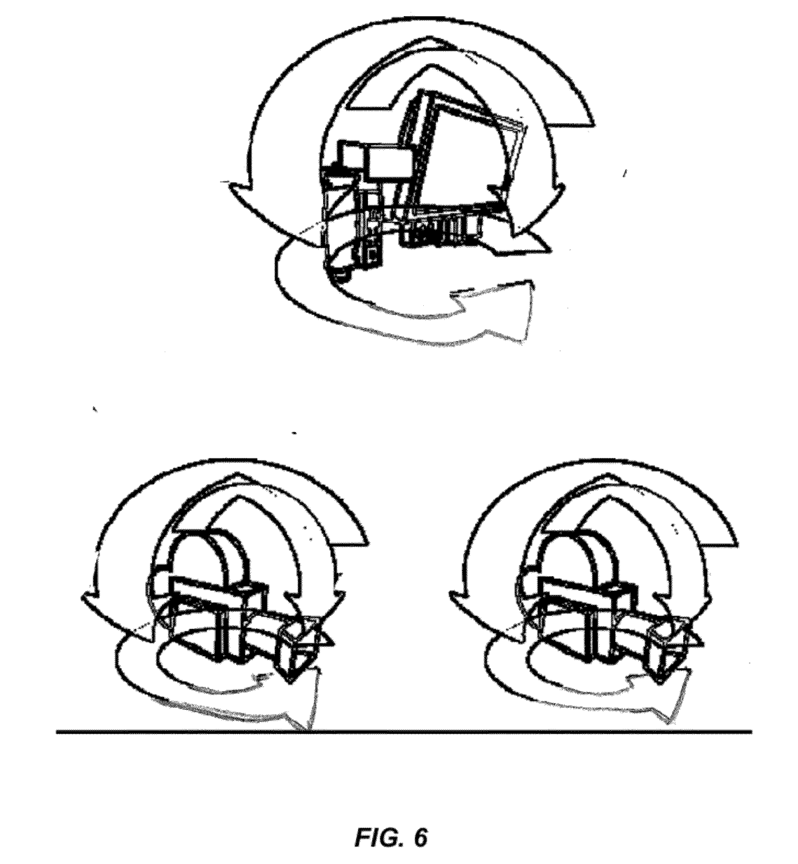

FIG. 5 illustrates a freeze and offset function of a virtual directors' camera according to an embodiment. The camera freeze function provides an option to suspend all manipulation on the virtual camera, even though the physical camera may still be moving. This allows the camera operator, typically a director, to position the view in a desirable location and to lock the camera down so that it does not need to be held in that location for the duration of the shot. When the virtual camera is “unfrozen,” it will snap back to the physical location in the space and be fully manipulated by the physical camera again. The action of freezing and unfreezing the camera can be performed at any time before, during or after the shot. One advantage of this feature is that it can provide the camera operator with additional flexibility with respect to manipulating the camera.

The camera offset function provides an option to position the virtual camera a predetermined distance away from the physical camera while maintaining full one-to-one (1:1) control over the virtual camera. This action can be done in conjunction with the camera freeze feature. The camera operator can freeze the virtual camera in a desired location, manipulate the physical camera to a location that is comfortable to operate with, and then “offset” the virtual camera to be manipulated again. This offset will “unfreeze” the frozen virtual camera, but will not make it “snap” back to the physical camera's location. In an example embodiment, the end result can be an offset between the physical and virtual cameras, as shown in FIG. 5. This feature can be desirable when the camera operator wants to capture a scene while being the least obtrusive as possible. For example, rather than standing between a group of actors and breaking their eye line during interaction, the director operating the camera can capture the complete scene without standing in the midst of the group of actors. This can allow additional flexibility for example, if an actor is running toward a director who is operating the camera and if the director wishes for the actor to run past them without hitting the camera.

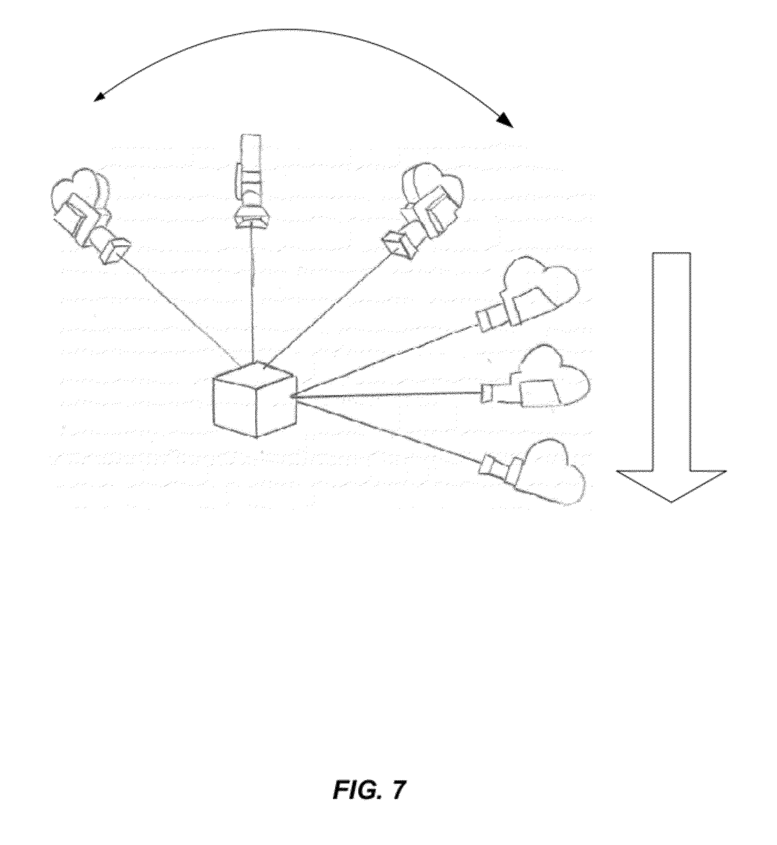

FIG. 6 illustrates a steady camera mode of a virtual directors' camera according to an embodiment. A steady camera mode, or steadicam, allows for the removal of Z-axis rotation. This can provide a smooth, un-shaky camera effect as it prevents the camera operator from being able to rotate the camera.

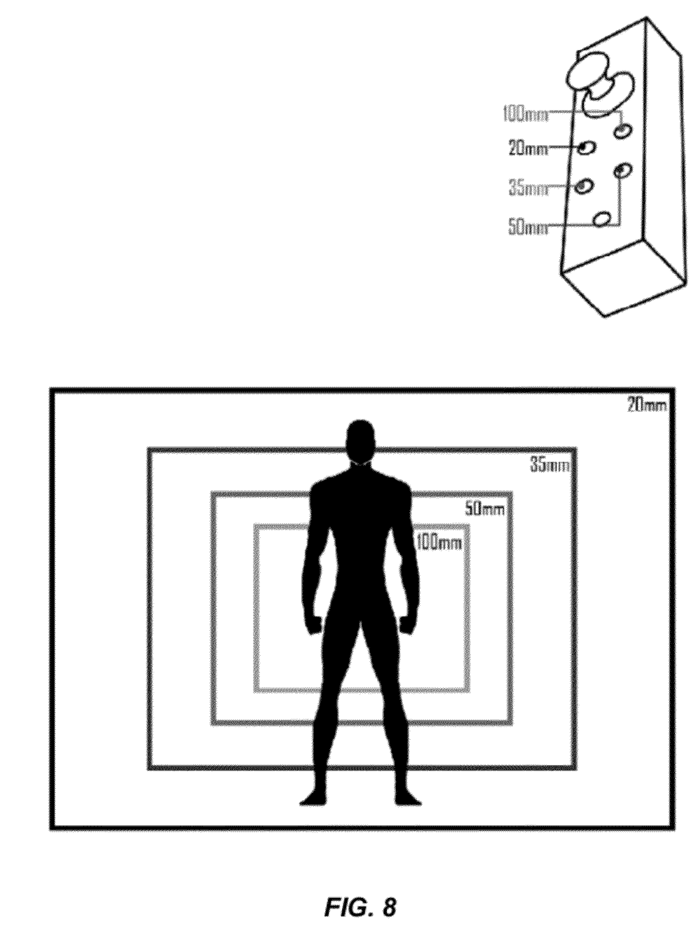

FIG. 7 illustrates a smooth boom feature of a virtual directors' camera according to an embodiment. A smooth boom feature, also known as techno crane, allows a director to place an interest on the virtual camera while in camera mode. The virtual camera will continue to point at a set point of interest, even if the physical camera is rotated. Translations remain the same as dictated by regular crane operation. Such a feature can provide advantages with respect to allowing for smooth operation of the crane, for example, with the crane fixed at a pointing to a set location in a scene, it is easier to capture wide zoom-ins and zoom-outs with precision and smooth operation.

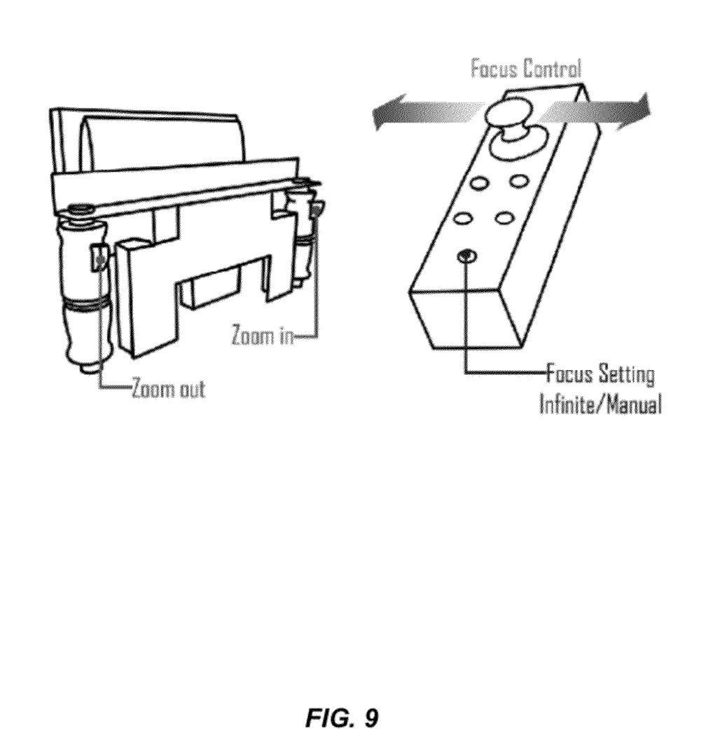

FIG. 8 illustrates a focal length feature associated with a virtual directors' camera system according to an embodiment. The virtual camera can include a plurality of default “prime” lenses. In an embodiment, a director can switch back and forth between each of these lenses. The lenses can provide the ability to mimic their real world, physical camera counterparts. In an embodiment, the “prime” lenses can include 20 mm, 35 mm, 50 mm and 100 mm lenses, which can be controlled on the virtual directors' camera system by pressing buttons on the controller as shown in FIG. 8. (See also FIG. 2, Button Configurations.) In addition to simulating a focal length, “picture” and “film” formats of the virtual camera can be changes to accommodate physical camera dynamics. In an example embodiment, one configuration type could be performed at NTSC specifications on a 35 mm TV projection simulated film type. In another example, a configuration type could be performed at PAL on a 16 mm theatrical simulated film type.

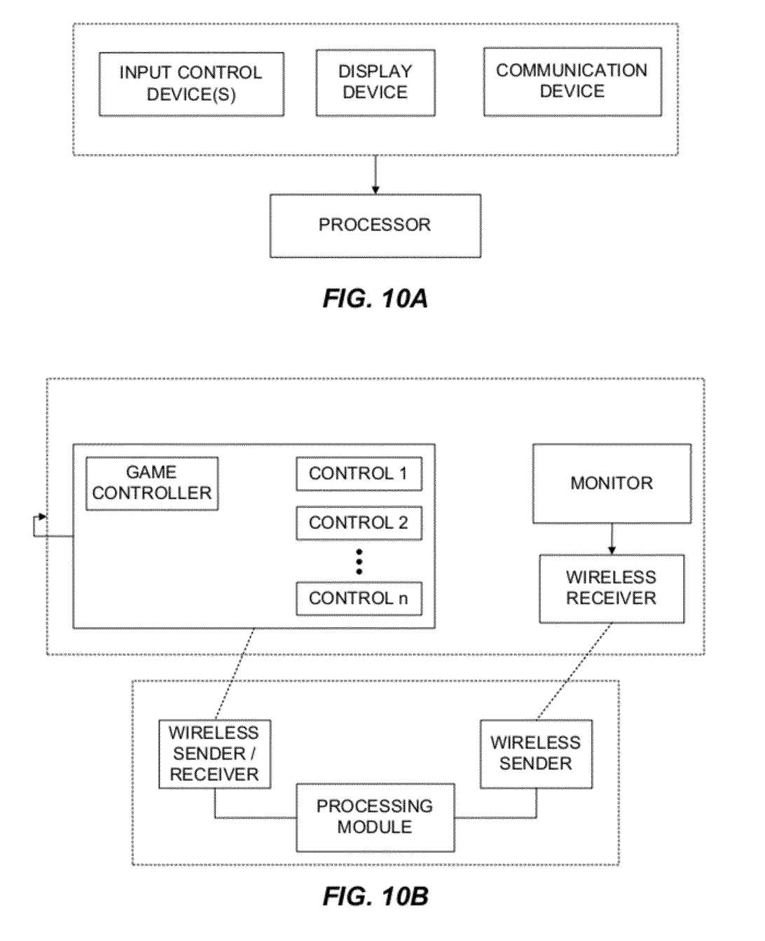

FIG. 9 illustrates a zoom and focus feature associated with a virtual directors' camera according to an embodiment. The virtual camera can include a controllable zoom feature. In an example embodiment, the zoom feature can include pressure sensitive controls in which the speed of the zoom is proportional to how hard the operator presses on a zoom paddle, for example, a harder press can equate to a faster zoom. The virtual camera can also include a focus feature that is switchable between an automatic mode and a manual mode. In automatic mode, the camera can have an infinite view field, that is, everything will be in focus. In manual mode, the director can control what is in focus and what is not. In an embodiment, an analog stick controller can be used in such a way that moving the focus stick is like moving the focus ring on a camera, where the operator can push focus far away or pull to bring focus right up to the camera lens. FIG. 9 shows a controller including a “focus setting infinite/manual” button and a focus stick. (See also FIG. 2, Button Configuration, for an example of how this can be incorporated into a virtual directors' camera system.)

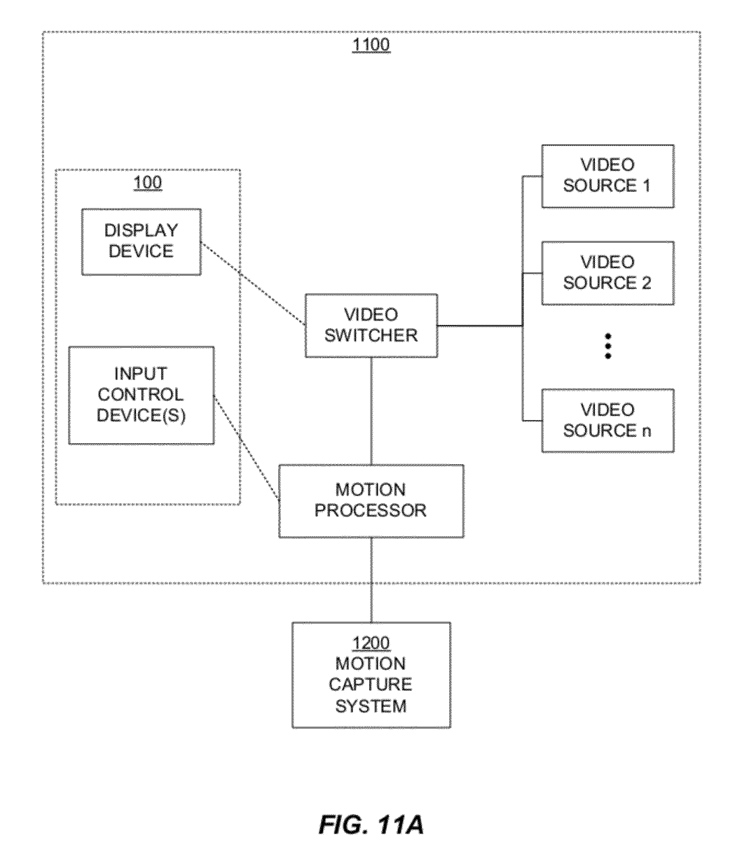

FIG. 10 illustrates a block diagram of a virtual directors' camera system according to an embodiment. The system includes a camera module wirelessly connected to a processing module. The camera module includes a controller module.

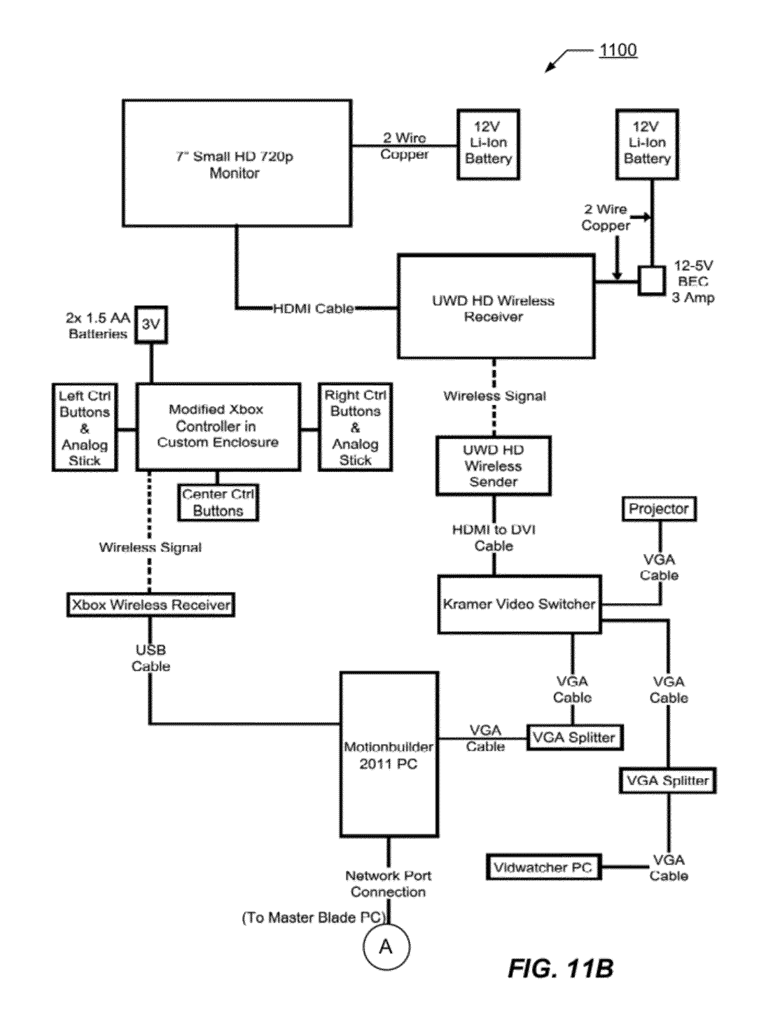

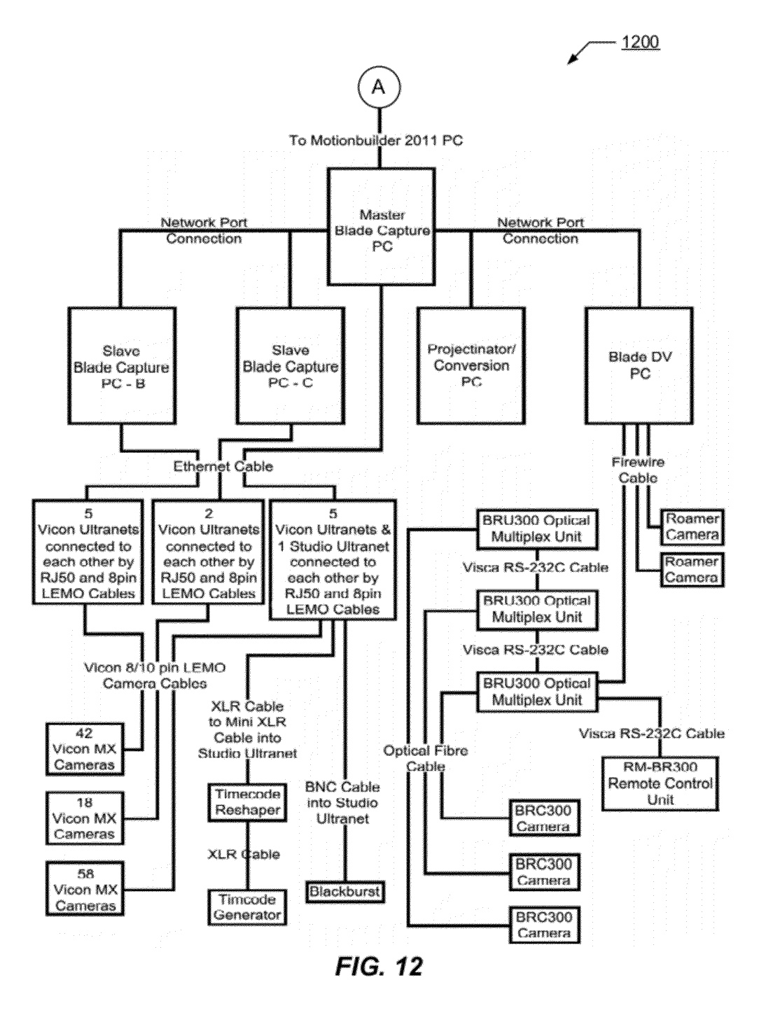

FIG. 11-12 illustrate a block diagram of a virtual directors' camera system according to an embodiment.

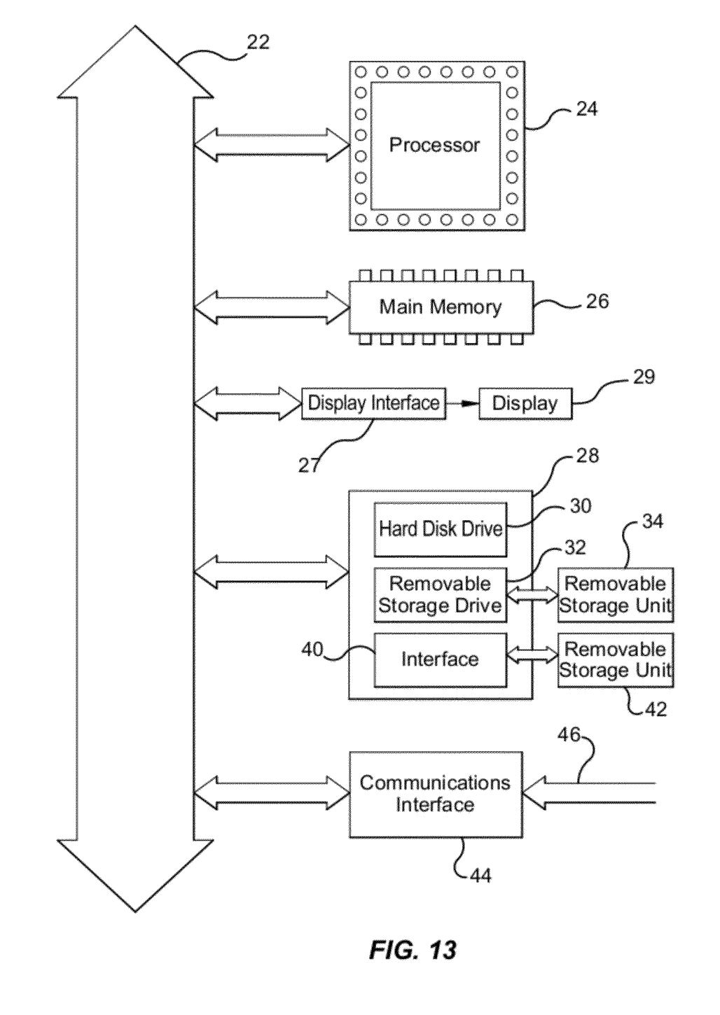

FIG. 13 illustrates a block diagram of a general purpose processing system of a virtual directors' camera system according to an embodiment.

The above-described devices, systems, and subsystems of the exemplary embodiments can include, for example, any suitable servers, workstations, PCs, laptop computers, PDAs, Internet appliances, handheld devices, cellular telephones, wireless devices, other devices, and the like, capable of performing the processes of the exemplary embodiments. Multiple devices and subsystems according to the exemplary embodiments can communicate with each other using any suitable protocol and can be implemented using one or more programmed computer systems or devices.

One or more interface mechanisms can be used with the exemplary embodiments, including, for example, Internet access, telecommunications in any suitable form (e.g., voice, modem, and the like), wireless communications media, and the like. For example, employed communications networks or links can include one or more wireless communications networks, cellular communications networks, G3 communications networks, Public Switched Telephone Network (PSTNs), Packet Data Networks (PDNs), the Internet, intranets, any form of cloud computing, a combination thereof, and the like.

It is to be understood that the devices and subsystems of the exemplary embodiments are for exemplary purposes, as many variations of the specific hardware used to implement the exemplary embodiments are possible, as will be appreciated by those skilled in the relevant art(s). For example, the functionality of one or more of the devices and subsystems of the exemplary embodiments can be implemented via one or more programmed computer systems or devices.

To implement such variations as well as other variations, a single mobile device or computer system can be programmed to perform the special purpose functions of one or more of the devices and subsystems of the exemplary embodiments. On the other hand, two or more programmed computer systems or devices can be substituted for any one of the devices and subsystems of the exemplary embodiments. Accordingly, principles and advantages of distributed processing, such as redundancy, shared information between users, replication, and the like, also can be implemented, as desired, to increase the robustness and performance of the devices and subsystems of the exemplary embodiments.

The devices and subsystems of the exemplary embodiments can store information relating to various processes described herein. This information can be stored in one or more memories, such as a hard disk, optical disk, magneto-optical disk, RAM, and the like, of the devices and subsystems of the exemplary embodiments. One or more databases of the devices and subsystems of the exemplary embodiments can store the information used to implement the exemplary embodiments of the present inventions. The databases can be organized using data structures (e.g., records, tables, arrays, fields, graphs, trees, lists, and the like) included in one or more memories or storage devices listed herein. The processes described with respect to the exemplary embodiments can include appropriate data structures for storing data collected and/or generated by the processes of the devices and subsystems of the exemplary embodiments in one or more databases thereof.

All or a portion of the devices and subsystems of the exemplary embodiments can be conveniently implemented using one or more general purpose computer systems, microprocessors, digital signal processors, micro-controllers, and the like, programmed according to the teachings of the exemplary embodiments of the present inventions, as will be appreciated by those skilled in the computer and software arts. Appropriate software can be readily prepared by programmers of ordinary skill based on the teachings of the exemplary embodiments, as will be appreciated by those skilled in the software art. Further, the devices and subsystems of the exemplary embodiments can be implemented on the World Wide Web. In addition, the devices and subsystems of the exemplary embodiments can be implemented by the preparation of application-specific integrated circuits or by interconnecting an appropriate network of conventional component circuits, as will be appreciated by those skilled in the electrical art(s). Thus, the exemplary embodiments are not limited to any specific combination of hardware circuitry and/or software.

Stored on any one or on a combination of computer readable media, the exemplary embodiments of the present inventions can include software for controlling the devices and subsystems of the exemplary embodiments, for driving the devices and subsystems of the exemplary embodiments, for enabling the devices and subsystems of the exemplary embodiments to interact with a human user, and the like. Such software can include, but is not limited to, device drivers, firmware, operating systems, development tools, applications software, and the like. Such computer readable media further can include the computer program product of an embodiment of the present inventions for performing all or a portion (if processing is distributed) of the processing performed in implementing the inventions. Computer code devices of the exemplary embodiments of the present inventions can include any suitable interpretable or executable code mechanism, including but not limited to scripts, interpretable programs, dynamic link libraries (DLLs), Java classes and applets, complete executable programs, Common Object Request Broker Architecture (CORBA) objects, and the like. Moreover, parts of the processing of the exemplary embodiments of the present inventions can be distributed for better performance, reliability, cost, and the like.

As stated above, the devices and subsystems of the exemplary embodiments can include computer readable medium or memories for holding instructions programmed according to the teachings of the present inventions and for holding data structures, tables, records, and/or other data described herein. Computer readable medium can include any suitable medium that participates in providing instructions to a processor for execution. Such a medium can take many forms, including but not limited to, non-volatile media, volatile media, transmission media, and the like. Non-volatile media can include, for example, optical or magnetic disks, magneto-optical disks, and the like. Volatile media can include dynamic memories, and the like. Transmission media can include coaxial cables, copper wire, fiber optics, and the like. Transmission media also can take the form of acoustic, optical, electromagnetic waves, and the like, such as those generated during radio frequency (RF) communications, infrared (IR) data communications, and the like. Common forms of computer-readable media can include, for example, a floppy disk, a flexible disk, hard disk, magnetic tape, any other suitable magnetic medium, a CD-ROM, CDRW, DVD, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave or any other suitable medium from which a computer can read.

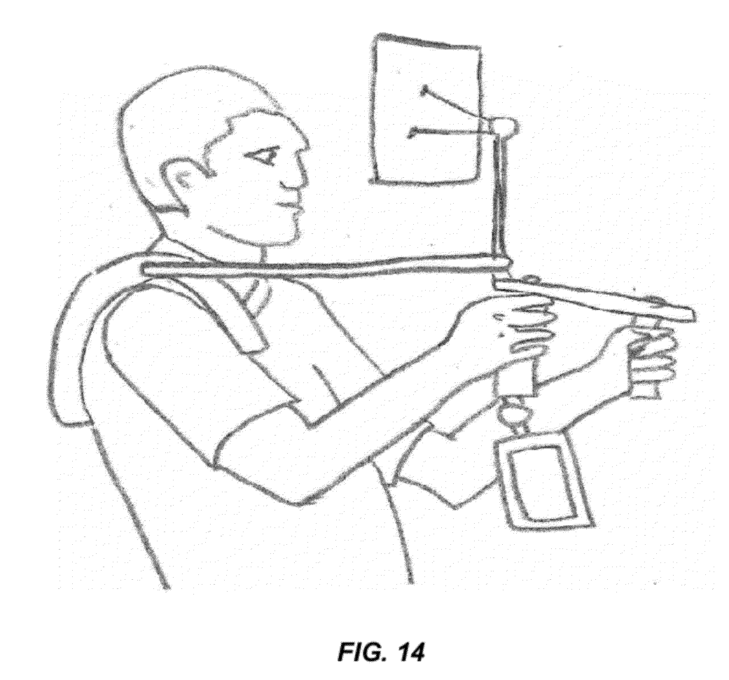

FIG. 14 is a diagram illustrating a mode of operation of a virtual directors' camera in accordance with an exemplary embodiment. In this embodiment, a frame or rig rests on the user's shoulders and can be used for attaching the display (which the user is looking at) and a controller (shown below the user's right hand. The virtual directors' camera includes a display screen, handles for holding the device, and a controller for changing the settings of the camera. In this example, the controller is in the form of a tablet device or tablet computer which can have a touch screen input. The display can show the action of the motion capture in a scene such as a virtual environment, and can also show the user interface of the software associated with camera operation and control. In one mode of operation, a director can hold onto the handles of the device and view the motion capture in a desired virtual environment, while also being able to control various aspects of the camera settings through a configuration of buttons on the controller of the device.

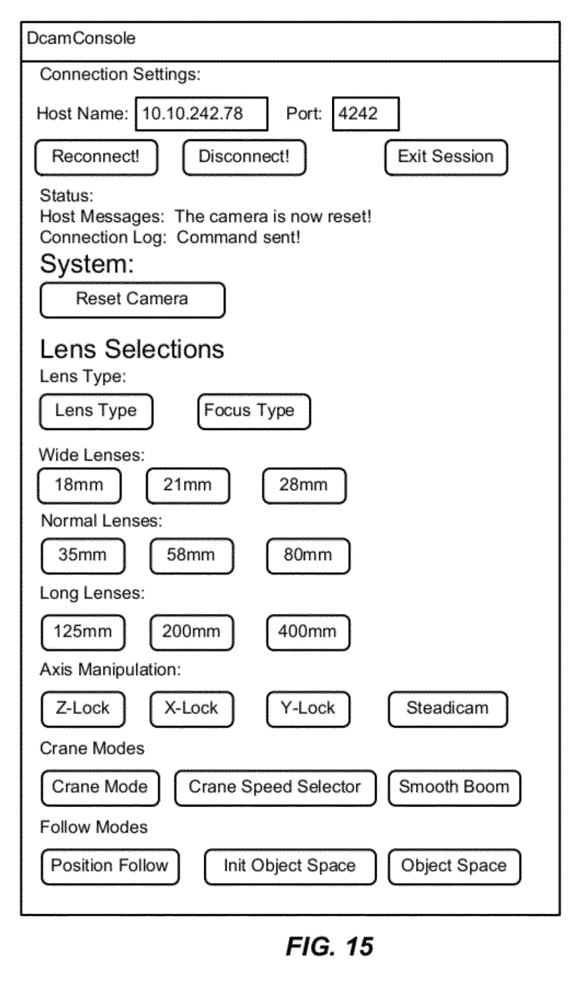

FIG. 15 is a diagram illustrating elements of a user interface of a virtual directors' camera system in accordance with an exemplary embodiment.

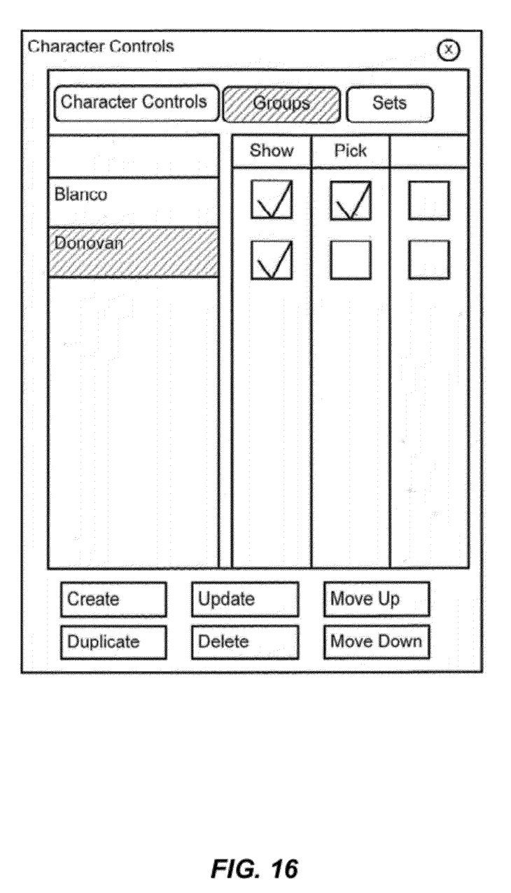

FIG. 16 is a diagram illustrating elements of a user interface of a virtual directors' camera system in accordance with an exemplary embodiment.

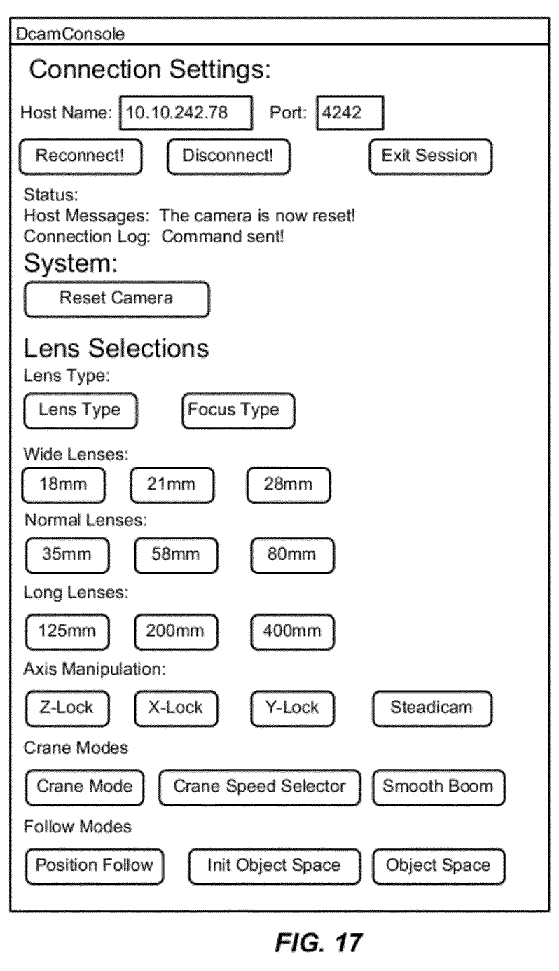

FIG. 17 is a diagram illustrating elements of a user interface of a virtual directors' camera system in accordance with an exemplary embodiment.

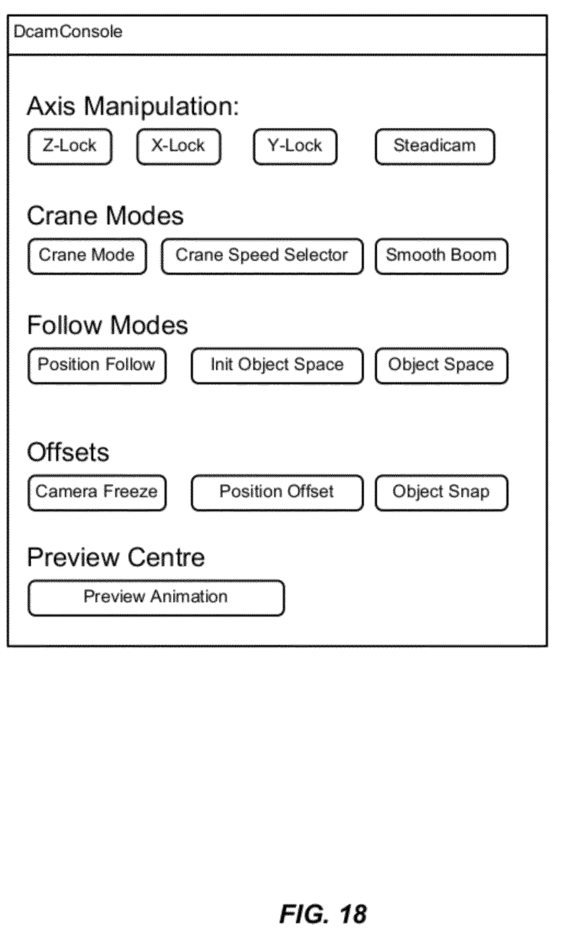

FIG. 18 is a diagram illustrating elements of a user interface of a virtual directors' camera system in accordance with an exemplary embodiment.

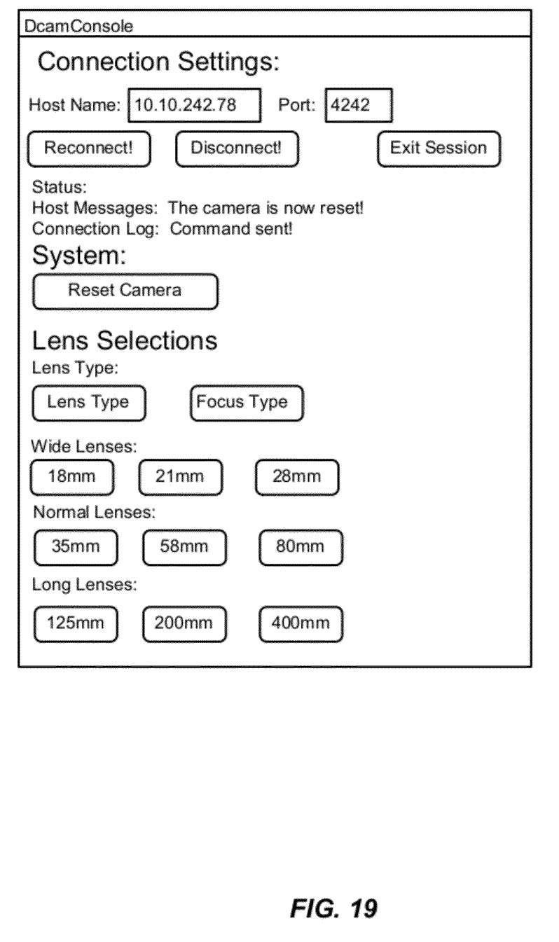

FIG. 19 is a diagram illustrating elements of a user interface of a virtual directors' camera system in accordance with an exemplary embodiment.

While the invention has been described with respect to exemplary embodiments, one skilled in the art will recognize that numerous modifications are possible. Thus, although the invention has been described with respect to exemplary embodiments, it will be appreciated that the invention is intended to cover all modifications and equivalents within the scope of the following claims.

What is claimed is:

1. A virtual directors' camera system, comprising:
a camera module configured to capture the motion of a body in a physical environment;
a processing module communicatively coupled to the camera, wherein the processing module associates the body motion with a virtual environment; and
a controller module communicatively coupled to the camera for adjusting a plurality of viewing parameters.

2. The virtual directors' camera system of claim 1, wherein the system is wireless.

3. The virtual directors' camera system of claim 1, wherein the controller module includes at least one of: a crane function, a camera freeze and offset function, a steady camera mode, a smooth boom mode, character selection, environment selection, focal length selection, zoom, and focus.

4. The virtual directors' camera system of claim 1, wherein the controller module is a tablet computer having a software implemented user interface.
